(19) United States
(12) Patent Application Publication
(10) Pub. No.: US 2008/0173754 A1
(43) Pub. Date: Jul. 24, 2008

(54) METHOD FOR DAMPING REAR EXTENSION ARM VIBRATIONS OF ROTORCRAFT AND ROTORCRAFT WITH A REAR EXTENSION ARM VIBRATION DAMPING DEVICE

(75) Inventors: Henning Strehlow, Muenchen (DE); Heiner Rottmayr, Raubling (DE); Johannes K. Duerr, Meersburg (DE); Helmut W. Zaglauer, Bodman-Ludwigshafen (DE)

Correspondence Address: DARBY & DARBY P.C., P.O. BOX 770, Church Street Station, New York, NY, 10008-0770, US

(73) Assignee: Airbus Deutschland GmbH, Hamburg (DE)

(21) Appl. No.: 11/868,061

(22) Filed: Oct. 5, 2007

Related U.S. Application Data
(62) Division of application No. 10/543,389, filed on Apr. 17, 2006.

(30) Foreign Application Priority Data
Feb. 3, 2003 (DE) 10304336.5

(51) Int. Cl. B64C 27/00

(52) U.S. Cl. 244/17.13

(57) ABSTRACT

A method for damping vibrations in a tail boom of a rotary-wing aircraft includes the steps of detecting tail boom vibrations induced by external vibration excitation, and generating and introducing strains into the tail boom based on the detected tail boom vibrations. The strains are applied over a surface area and are out-of-phase with respect to the detected tail boom vibrations so as to damp the externally excited induced tail boom vibrations. In addition, a rotary-wing aircraft, includes a fuselage, a cockpit area integrated into the fuselage, a tail boom arranged on the fuselage and a tail boom vibration-damping device. The vibration-damping device has at least one sensor element configured to detect tail boom vibrations induced by external vibration excitation and at least one actuator configured to generate and introduce strains into the tail boom that are out-of-phase with respect to the induced tail boom vibrations, the actuator being functionally coupled to the sensor element, engaging with a tail boom structure at one side of the tail boom, and forming a flat-surfaced bond with the tail boom.

The present invention relates to a method for damping tail boom vibrations of rotary-wing aircraft, especially helicopters, as well as a rotary-wing aircraft, especially a helicopter, with a tail boom vibration-damping device.

### BACKGROUND

Aeronautic structures are increasingly being made of fiber composite materials for purposes of weight reduction. By nature, such structures are highly rigid and have a low inherent damping. This also applies, for example, to the tail booms of modern rotary-wing aircraft such as, for example, helicopters.

Although the development of modern helicopters involves extensive numerical flow simulations and wind tunnel experiments, undesired tail boom vibrations often occur in actual practice that cause the entire helicopter cell structure to vibrate or that can be felt throughout the entire helicopter. The tail boom vibrations can generally be divided into two typical types of vibration or forms of vibration, which are referred to as “tail shake” and “vertical bouncing”. Tail shake refers to externally excited, induced vibrations of the tail boom in the lateral direction (lateral eigenform) while vertical bouncing refers to externally excited, induced vibrations in the vertical direction (vertical eigenform) that propagate throughout the entire helicopter structure and can be felt in the entire helicopter.

Tail shake and vertical bouncing are typical phenomena encountered in rotary-wing aircraft or helicopters. Tail shake stems, on the one hand, from the interaction of the turbulent wake of the main rotor or of the helicopter cell and of the turbine or driving gear cladding with the structure of the tail boom and, on the other hand, from the changeable lateral air load which, due to the unsteady vortex shedding in the wake of the tail boom, is introduced into its structure (so-called lock-in phenomenon during vortex shedding). Vertical bouncing is caused especially by turbulence excitation and control feedback, possibly with the unintentional participation of the pilot. Normally speaking, the vibrations caused by tail shake or vertical bouncing (depending on the type of helicopter and on its flight condition) are especially noticeable at flying speeds of about 70 to 120 knots. So far, in spite of intensive efforts on the part of the technical community, it has not yet been possible to reliably predict the interaction between the aerodynamics and the helicopter structure.

In the case of the low-frequency stochastic vibrations or vortex resonance vibrations of the helicopter cell structure that occur rather irregularly and randomly in the vertical and lateral directions during tail shake or vertical bouncing, superimpositions also occur that result in beats. All of these vibrations affect flight control in a very negative manner, but they are not primarily a safety-relevant problem. Since it is mainly the low elastic modes of the helicopter structure that are excited in a range from approximately 5 Hz to 8 Hz, and since the resultant structure modes have two vibration nodes, they are perceived by the helicopter crew especially in the area in front of the front vibration node—that is to say, primarily in the cockpit area of the helicopter. As a result, these effects have a detrimental impact on the pilots in particular but also on the passengers, considerably diminishing comfort or even impairing performance. Due to the superimposition of the two above-mentioned types of vibration, the helicopter crew—in addition to being exposed to lateral and vertical impacts—is also at times subjected to sudden low-frequency vibrations that result from such impacts and that manifest themselves in the form of jolting. In order to illustrate the phenomena resulting from tail boom vibrations, FIG. 1 shows a time-dependent vibration curve with superimposed beats, measured on a pilot's seat in a helicopter according to the state of the art.

Various studies and experiments have been carried out in order to prevent tail shake and vertical bouncing as well as the associated above-mentioned negative effects or to at least reduce them to such an extent that they are no longer perceived by the crew and passengers of a helicopter.

A first approach was aimed at improving the aerodynamic properties in the area of the rotor, engine and driving gear of the helicopter, which was attempted by installing suitable cladding of the above-mentioned components. However, this solution turned out to have rather limited usefulness in terms of the attainable tail boom damping properties.

A second approach was aimed at increasing the structure damping of the tail boom by using additional passive damping materials or dampers. A drawback here turned out to be, on the one hand, the additional weight introduced into the overall system by the additional passive damping elements and, on the other hand, their quite limited effectiveness.

Consequently, the desired technical success could not be achieved with any of these approaches.

U.S. Pat. No. 5,816,533 describes a method for damping tail boom vibrations of helicopters as well as a helicopter equipped with a tail boom vibration-damping device. With this method or this helicopter, the adjustable tail rotor of the helicopter is the main component of the tail boom vibration-damping device. The tail rotor is incorporated in a closed control loop. Tail boom vibrations in the form of a tail shake are detected by sensors and are damped by counter-regulation effectuated by the tail rotor. However, this method and this helicopter construction have not proven to be successful. On the one hand, only the tail shake effect can be damped with this method and on the other hand, the tail rotor is only effective to a limited extent for damping purposes and, in particular, it is also much too slow. Therefore, the damping effect is minimal. Furthermore, a tail rotor is a highly safety-relevant component that should not be used for other purposes since the failure of such a safety-relevant system can greatly jeopardize the flight properties of the helicopter and thus the overall safety. Consequently, this solution has proven to be disadvantageous.

### SUMMARY OF THE INVENTION

An object of the present invention is to provide an effective method for damping tail boom vibrations of rotary-wing aircraft as well as creating a rotary-wing aircraft, especially a helicopter, with improved tail boom vibration properties and thus greater flight comfort.

This method for damping tail boom vibrations of rotary-wing aircraft, especially helicopters, comprises the following steps:
detecting tail boom vibrations induced by external vibration excitation; and, on the basis of the detected induced tail boom vibrations, generating and introducing strains applied over a surface area into the tail boom that are out-of-phase with respect to the induced tail boom vibrations, thereby damping the externally excited induced tail boom vibrations.

According to the invention, the detection of the tail boom vibrations as well as the introduction of the out-of-phase strain (elongations and/or contractions) into the tail boom and thus ultimately the damping of the tail boom vibrations can occur in one or more axes or vibration planes.

According to the invention, in order to achieve the damping effect, only elongations, only contractions or else both elongations and contractions can be introduced. These introduced out-of-phase strains lead to a deflection or strain of the tail boom or adjacent fuselage structures and adjacent add-on components (e.g. fuselage cell, horizontal tail unit, rudder unit, main rotor torque-compensation devices such as, for example, a tail rotor and its components, tail boom joints in case of collapsible tail booms, etc.) that is out-of-phase with respect to the tail boom vibrations in question. In this manner, the undesired induced tail boom vibrations or vibration amplitudes that can, in fact, be felt in the entire rotary-wing aircraft can be markedly reduced or entirely neutralized. Due to these achievable advantageous vibration damping effects, a significant improvement can be achieved in the comfort of the pilot and passengers on board the rotary-wing aircraft.

With the solution according to the invention, the damping effect—unlike with the state of the art—is not limited to a only certain vibration direction but, depending on the location and direction of the introduction, can fundamentally be used for virtually any vibration direction that might occur. Therefore, with the method according to the invention, for example, tail shake effects (lateral) as well as vertical bouncing effects (vertical) can be effectively damped. The damping of the individual types of vibration can take place independently of each other or else together or simultaneously. Moreover, of course, it is also possible to achieve a highly effective damping of tail boom vibrations that have an orientation other than that of tail shake or vertical bouncing. Thus, on the basis of the principle according to the invention, for example, torsional vibrations can likewise be damped. By the same token, the damping of correspondingly superimposed forms of vibration is possible. Consequently, with the method according to the invention, the structure damping of the tail boom and thus ultimately also the damping of the entire rotary-wing aircraft structure can be improved simply and effectively.

The positive effect of the method according to the invention can be achieved fundamentally independently of the material of the tail boom or of the fuselage structure of the rotary-wing aircraft as well as of any add-on components. In other words, for instance, it is possible to effectively damp vibrations of tail booms or of adjacent fuselage structures made of materials such as, for example, fiber composites, which tend to have poor inherent damping properties. The method according to the invention even allows the damping of very large and highly rigid aeronautic structures. The method according to the invention can fundamentally be used for any type of rotary-wing aircraft or helicopter. Moreover, it is relatively simple in terms of its construction and can be produced with comparatively simple equipment, as will be explained below in greater detail.

The present invention also provides a rotary-wing aircraft, especially a helicopter, that comprises a fuselage, a cockpit area integrated into the fuselage, a tail boom arranged on the fuselage as well as a tail boom vibration-damping device having at least one sensor means for detecting tail boom vibrations induced by external vibration excitation as well as at least one actuator that engages with a tail boom structure at one side of the tail boom and that is functionally coupled to the sensor means, for generating and introducing strains into the tail boom that are out-of-phase with respect to the induced tail boom vibrations.

The rotary-wing aircraft according to the invention offers essentially the same advantages as those already described in conjunction with the method according to the invention. Moreover, conventional rotary-wing aircraft can be converted into a rotary-wing aircraft according to the invention relatively simply as will become even more evident below. Moreover, the solution according to the invention (and here especially the at least one actuator that engages with a tail boom structure at one side of the tail boom for generating and introducing strains into the tail boom that are out-of-phase with respect to the induced tail boom vibrations) is not a safety-relevant system whose failure would jeopardize the flight properties or the safety of the rotary-wing aircraft.

Preferred embodiments of the invention with additional configuration details and further advantages are described and explained below with reference to the accompanying drawings.

### BRIEF DESCRIPTION OF THE DRAWINGS

The following is shown:

FIG. 1 an example of a time-dependent vibration curve with superimposed beats, measured on a pilot's seat in a rotary-wing aircraft according to the state of the art;

FIG. 2 a schematic perspective view of an essential area of a rotary-wing aircraft according to the invention in a first embodiment;

FIG. 3 a schematic enlarged view of the detail X of FIG. 2;

FIG. 4 schematic views of different actuators that can be used in rotary-wing aircraft according to the invention and in the method according to the invention;

FIG. 5 a schematic perspective grid line depiction of an essential area of a rotary-wing aircraft according to the invention in a second embodiment, for purposes of illustrating a method according to the invention;

FIG. 6 a first schematic circuit diagram for a simple passive damping;

FIG. 6a a second schematic circuit diagram for a passive damping;

FIG. 6b a third schematic circuit diagram for a passive damping;

FIG. 7 a schematic diagram by way of an example for illustrating the tail boom damping behavior that can be achieved on the basis of the method according to the invention regarding the tail shake effect in a rotary-wing aircraft according to the invention;

FIG. 8 a schematic top view of a tail boom area of a rotary-wing aircraft according to the invention in a third embodiment.

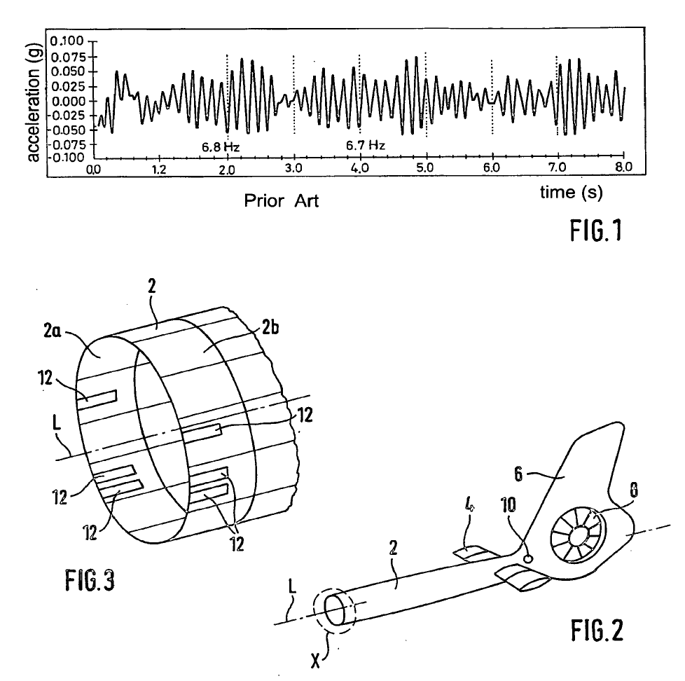

### DETAILED DESCRIPTION OF PREFERRED EMBODIMENTS

In order to avoid repetitions, in the description below and in the figures, the same parts and components are also designated with the same reference numerals as long as no differentiation is necessary.

FIG. 2 shows a schematic perspective view of an essential area of a rotary-wing aircraft according to the invention in a first embodiment in order to illustrate a method according to the invention in a first embodiment. FIG. 3 shows a schematic enlarged view of the detail X from FIG. 2. In this case, the rotary-wing aircraft is a helicopter that has a fuselage with a main rotor and a drive means, a cockpit and passenger cabin area that is integrated into the fuselage as well as a tubular tail boom 2 that is arranged on the fuselage. The fuselage and the tail boom 2 are made essentially of fiber composite materials such as, for example, carbon fiber composite materials. For the sake of clarity, FIG. 2 shows only the tail boom 2 with its add-on components. In this case, these add-on components are a horizontal tail unit 4 mounted on the rear area of the tail boom 2, a rudder unit 6 as well as a main rotor torque-compensation device 8 in the form of a so-called fenestron integrated into the rudder unit 6.

The helicopter is equipped with a tail boom vibration-damping device that, in the present embodiment, serves to damp the tail shake, that is to say, the horizontal eigenform of tail boom vibrations. The tail boom vibration-damping device has a sensor means with at least one vibration sensor 10 for detecting tail boom vibrations induced by external vibration excitation. In this example, a vibration velocity pick-up is used as the vibration sensor 10 that is preferably installed in a rear area of the tail boom 2 since this is where the highest vibration velocities occur in case of tail boom vibration so that this is where a good sensor signal can be obtained. By the same token, however, other suitable sensors such as, for example, strain sensors or the like could be used. Strain sensors should preferably be placed in the area of the fuselage joint of the tail boom 2 since this is where the largest strains occur in case of tail boom vibration.

The tail boom vibration-damping device also comprises one or more actuators 12 that engage with the tail boom structure on opposite sides of the tail boom 2, relative to the cross section of the tail boom 2 that can be seen in FIG. 3. To put it more precisely, the actuators 12 are arranged in the area of the fuselage joint of the tail boom 2 or at the transition area between the tail boom 2 and the fuselage on the left-hand and right-hand sides—relative to the normal forward flying direction of the helicopter—of the tail boom 2 and symmetrical to the middle longitudinal axis L of the tail boom 2. In case of tail boom vibrations, the places with the highest structural strain energy or the places with the highest bending moment of the tail boom 2 are normally in this area. In this embodiment, there is at least one actuator provided for each side of the tail boom. The above-mentioned arrangement on the left-hand and right-hand side of the tail boom corresponds to a preferred arrangement for damping the tail shake. In order to damp the vertical bouncing, the actuators 12 are preferably arranged on the top and bottom of the tail boom and/or on the top and bottom of the transition area between the tail boom 2 and the fuselage. In order to damp other forms or directions of vibration, other suitable attachment places can be selected correspondingly. In this context, places or sites that lie symmetrical to the longitudinal axis of the tail boom 2 are fundamentally preferred.

If tail shake as well as vertical bouncing are to be damped, then the actuators 12 have to be provided on both of the above-mentioned attachment areas (left, right, top, bottom). For the present examples, it is assumed for the sake of simplicity that only the tail shake is to be damped. The vertical bouncing is damped in fundamentally the same manner so that no separate explanation is necessary.

Within the scope of the solution according to the invention, preferably piezoelectric actuators or actuators on the basis of piezoceramic materials are used as the actuators 12. These include piezoelectric (PZT, PLZT) and electrostrictive (PMN) materials. In the case of piezoceramic materials, an electric field applied between two fields, that is to say, an applied electric voltage, leads to strains in the form of an elongation or contraction of the material as a function of the particular polarity. Actuators 12 made of such materials are thus capable of converting electric energy directly into mechanical energy. The above-described effect is reversible in the case of piezoelectric materials. In other words, in the case of a mechanical strain that can be changed over time and that is exerted onto such a material, a charge shift occurs between the electrodes that can be tapped via the electrodes, again as electric voltage or as an electric sensor signal. The actuators described above will be referred to below as piezoactuators 12. They entail advantages such as high actuating resolution, high actuating forces and very short response times along with a small design volume.

The piezoactuators 12 are preferably flat and plate-shaped. The actuating direction of such piezoactuators runs essentially parallel to the plate plane. The piezoactuators 12 can be provided, for example, in the form of piezoceramic films, thin plates, wafers or fibers, including piezoceramic fibers with an interdigital electrode. Several flat piezoactuators can also be arranged above each other in several discrete layers in order to form a flat, plate-like actuator packet. This is possible as a multi-layer structure or in a bimorph design. The piezoactuators 12 with a plurality of individual layers are preferably configured as so-called QuickPacks or as stack actuators. They have stacks of thin piezoceramic disks or fibers that, when exposed to an external electric field, lengthen or shorten approximately linearly along the longitudinal axis of the stack. In the case of QuickPacks that function on the basis of the piezoelectric d31 effect, as a rule, up to about five layers arranged above each other are practical. Stack actuators normally have far more individual layers (>>10) and function on the basis of the d33 effect, which is approximately twice as effective.

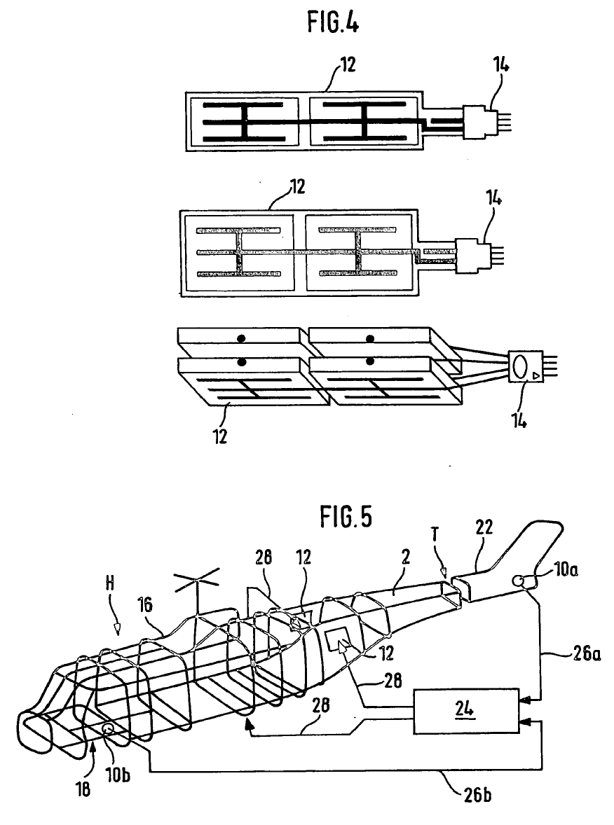

FIG. 4 shows schematic views of different two-layered flat piezoactuators 12 (here QuickPacks) that can be used in rotary-wing aircraft according to the invention as well as in the method according to the invention. These are flat, plate-shaped piezoactuators 12 on the basis of piezoelectric films. The left-hand upper part of FIG. 4 shows a standard actuator with the model designation QP40N and, to the right, an actuator with the model designation QP40W made by the ACX company. The QP40N actuator is made up of two consecutively arranged piezoceramic wafers per plane with two planes arranged above each other. The lower part of FIG. 4 shows a schematic diagram of a piezoactuator 12 with a circuit diagram. The small triangle on the connection 14 that can be seen on the right-hand side indicates the plus pole.

In the helicopter according to the invention as shown in the present embodiment, the plate-shaped piezoactuators 12 are suitably joined to the structure of the tail boom 2. This can be done, for example, in that the piezoactuators 12 are applied onto the tail boom structure by means of suitable joining methods, that is to say, for example, they are bonded directly onto the inner surface 2a, the outer surface 2b or both surfaces 2a, 2b of the tail boom 2 (see FIG. 3). This yields a flat-surfaced bond with the surface of the tail boom 2 that serves as the support structure. This technique is especially well-suited for retrofitting conventional helicopters with the technology according to the invention in a simple and effective manner.

However, the piezoactuators 12 can also be integrated into the tail boom structure. This variant is especially well-suited for flat piezoactuators 12 having a plate-like or fiber-shaped structure (see FIG. 4). Such actuators 12 can be laminated, for example, directly into the tail boom structure and can form a flat-surfaced bond with it, which lends itself especially well for modern tail boom constructions made of fiber composite materials. The lamination of the actuators 12 into the structure of the tail boom 2 (structural integration), however, already has to be carried out within the scope of the manufacture of the structure at the same time as its production. Moreover, it is, of course, possible to join one or more actuators 12 (e.g. stack actuators) to the tail boom structure via one or more discrete force-application elements (e.g. a strut or the like).

Depending on the shape of the tail boom 2, the piezoactuators 12 are aligned at their particular installation site in such a way that their actuating directions run essentially or approximately parallel to the middle longitudinal axis L of the tail boom 2 or else parallel to the surface 2a, 2b of the tail boom structure.

A free strain of the piezoactuators 12 is blocked since—due to the explained application or integration—the piezoactuators 12 are permanently joined to the tail boom structure. After the application of an electric current to the piezoactuators 12 and after the resultant elongation/contraction of the piezoactuators 12, the latter transfer their actuating forces or strains directly to the support structure, that is to say, the tail boom 2, and can induce strains or bending moments in the tail boom 2. The actuators 12 thus function as adjustable tail boom deformation elements or tail boom bending elements. Therefore, assuming suitable regulation, for example, with a control or actuation means, the use of piezoactuators 12 makes it possible to generate elongations and/or contractions that are out-of-phase with respect to the induced tail boom vibrations that occur during the operation of the helicopter and to introduce these vibrations into the tail boom 2.

The piezoactuators 12 are functionally coupled to the sensor device or to its vibration sensor(s) 10, that is to say, they can be checked as a function of the sensor signals emitted by the sensor means, as will be described in greater detail below. The helicopter according to the invention is also equipped with a control or regulation means that is coupled to the sensor means and to the piezoactuators 12 in order to allow a controlled actuation of the actuators (not shown in FIGS. 2 and 3, see FIG. 5). The control or regulation means comprises, among other things, actuation electronics for the piezoactuators 12, an amplifier as well as a suitable control or regulation algorithm. The tail boom vibration-damping device and its components are supplied by a suitable source of energy (not shown here), for example, a source of current or voltage.

FIG. 5 shows a schematic perspective grid line depiction of an essential area of a rotary-wing aircraft according to the invention, namely, of a helicopter H, in a second embodiment. This depiction also serves to illustrate a method according to the invention. FIG. 5 shows the entire cell structure of the helicopter H including the fuselage 16 with the cockpit area 18, the passenger cabin 20 and the tail boom 2. The arrangement of the piezoactuators 12 corresponds essentially to that of the helicopter according to the first embodiment (FIGS. 2 and 3). Unlike in the first embodiment, the helicopter H according to FIG. 5, however, has a rear tail boom area 22 that is collapsible, that is to say, that can be pivoted laterally around a drag-link by means of an appropriate folding and locking means. The separation plane that runs through the foldable tail boom part in the area of the drag-link and that divides the tail boom 2 into a front and a rear tail boom part is indicated by the reference letter T. Such a separation plane T is a discontinuity site in the bending line of the entire tail boom 2.

The helicopter H shown in FIG. 5 is equipped with two vibration velocity sensors 10a, 10b, which in this case are arranged on the rear tail boom part 22 and in the cockpit area 18. Each sensor 10a, 10b is coupled via the control or regulation means 24 to the piezoactuators 12 that are installed on the left-hand and right-hand sides of the tail boom.

The method according to the invention for damping a lateral eigenform (tail shake) of tail boom vibrations will now be described making reference to FIG. 5 and to the helicopter H according to the invention shown in said figure. Due to the configuration of the helicopter H according to the invention, different variants or modalities are possible.

### Variant A (Active Damping):

In the present example, as far as the sensor means is concerned, this is done using only the rear vibration velocity sensor 10a. When the tail shake effect occurs as a result of external vibration excitation, the tail boom 2, 22, due to external vibration excitation, executes induced vibrations in the lateral direction which cause strains in the tail boom structure because of the bending loads or bending deformations thus generated. These tail boom vibrations or the resultant vibration states of the helicopter H are picked up by the sensor 10a located on the rear tail boom part 22 and said sensor detects the vibration velocity of the tail boom 2, 22 and emits corresponding sensor signals 26a. Here, the sensor signals 26a are a measure of the vibration direction and vibration velocity occurring momentarily in the area of the sensor 10a. If another type of sensor were to be used, for example, a strain sensor arranged in the transition area to the fuselage 16, then the induced tail boom vibrations would advantageously be detected by picking up structural strains of the tail boom induced by the vibrations.

The sensor signals 26a are fed to the control or regulation means 24. It then uses the control or regulation algorithm to generate actuation signals 28 for the piezoactuators 12. These actuation signals 28 are transmitted via the actuation electronics and the amplifier to the piezoactuators 12.

The actuation of the piezoactuators 12 is carried out here in such a way that the piezoactuators 12 are each deflected out-of-phase and with an out-of-phase velocity with respect to the tail boom vibrations. Since in the present embodiment, there are piezoactuators 12 on both sides of the tail boom 2, 22, they are also actuated in the opposing manner here. This means that, when the piezoactuators 12 located on the left-hand side of the tail boom execute an elongation, then the piezoactuators 12 located on the right-hand side of the tail boom execute a contraction. Of course, this presupposes that the selected piezoactuators 12 are configured for both actuation modes (elongation and contraction). If the piezoactuators 12 are only configured for one of these actuation modes, then it would be necessary to alternately actuate only the piezoactuators 12 of one side of the tail boom. The above-mentioned opposing actuation with two actuation modes is, of course, more effective.

Through the actuation of the piezoactuators 12 that is carried out on the basis of the detected tail boom vibrations, strains or bending moments oriented opposite to the vibration-related structural strain of the tail boom 2, 22 are introduced into the tail boom structure. Owing to the described arrangement of piezoactuators 12, the out-of-phase elongations and contractions are introduced at the places with the highest structural strain energy or at the places with the highest bending moment of the tail boom 2, 22. In this manner, a highly effective active vibration damping of the lateral eigenform (tail shake) of the tail boom vibrations is achieved.

### Variant B (Passive Damping):

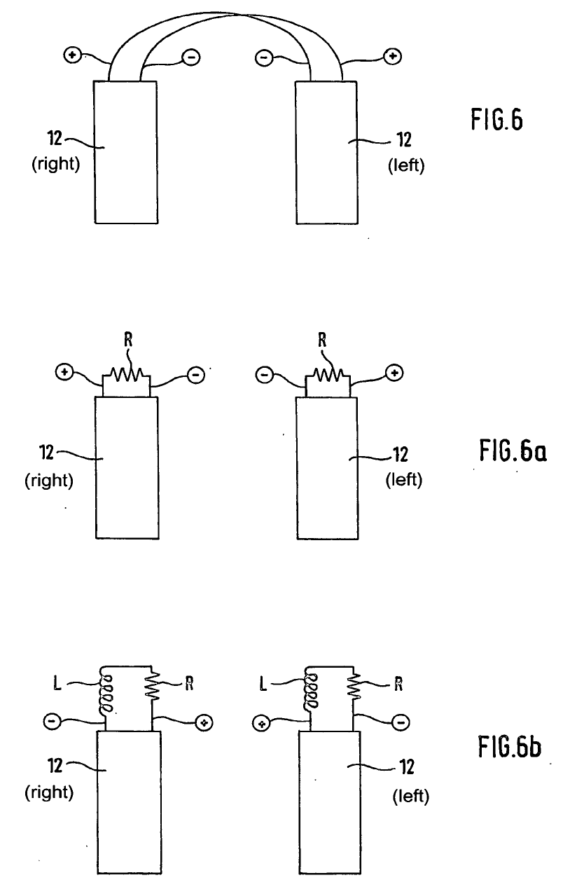

In the present example, as far as the sensor means is concerned, this is likewise done using only the rear vibration velocity sensor 10a. Here, however, unlike in Variant A, no separate control or regulation means 24 with actuation electronics, amplifier and separate source of current or voltage are used. Instead, the piezoactuators 12 on one side of the tail boom (left) are functionally connected via a passive electric circuit (not shown here) to the piezoactuators on the other side of the tail boom (right). When tail boom vibrations occur, the piezoactuators 12, which are firmly attached to the tail boom structure, are stretched or squeezed. Thus, by utilizing the resultant reverse piezo effect (see above), the signals emitted by the piezoactuators 12 on one side are transmitted as actuation signals to the piezoactuators 12 of the other side and vice versa. Thus, the piezoactuators 12 on both sides of the tail boom are each actuated out-of-phase with respect to the tail boom vibrations. In this manner, a passive vibration damper of the tail boom vibrations is achieved. FIG. 6 shows a first schematic circuit diagram for a simple passive damping of the type described above.

### Variant B1 (Passive Damping):

FIG. 6a shows a second schematic circuit diagram for another passive damping. In this variant, the damping is increased by converting the energy in a resistor R. Here, the electric energy generated in the passive actuator 12 in question is converted into heat in the resistor R. This separate, independent energy conversion takes place without connection of the actuators 12 or actuator groups located on both sides of the tail boom.

### Variant B2 (Passive Damping):

FIG. 6b shows a third schematic circuit diagram for another passive damping. In this variant, the damping is increased by converting energy in an R-L member. Here, the electric energy generated in the passive actuator 12 in question is converted into heat in the R-L member. This separate, independent energy conversion likewise takes place without connection of the actuators 12 or actuator groups located on both sides of the tail boom.

Variants B1 and B2 can fundamentally be used for Variant B insofar as the actuators 12 (left and right) are electrically connected to an actuator (or an actuator field).

### Variant C (Active Damping):

In the present example, as far as the sensor means is concerned, this is done using only the front vibration velocity sensor 10b located in the cockpit area 18. This sensor 10b detects the tail boom vibrations in the cockpit area 18, which can be felt throughout the entire helicopter H. The sensor signals 26b of the sensor 10b are, in turn, fed to the control or regulation means 24 which then uses the control or regulation algorithm to generate actuation signals 28 for the piezoactuators 12. In this case, the control or regulation algorithm—and thus the actuation of the piezoactuators 12—is configured such that, during the damping of the lateral eigenform (tail shake), the vibrations occurring in the cockpit area 18 as a result of the tail shake are minimized or neutralized.

### Variant D (Active Vibration):

This variant corresponds largely to Variants A and C, but the tail boom vibrations are detected with both sensors 10a and 10b in the cockpit area 18 as well as in the tail boom 2, 22 itself. Moreover, the measuring signals 26a, 26b of both sensors 10a, 10b are fed to the control or regulation means 24. Here, the control or regulation algorithm is configured such that both sensor signals 26a, 26b are evaluated and appropriate actuation signals 28 are generated for the piezoactuators 12. It is evident that the necessary control or regulation algorithm is more complex than with Variants A and C, but it also allows a more differentiated damping control.

As set forth in the invention, it is also possible to combine the variants described above. Moreover, the variants described above can fundamentally also be augmented or combined with other sensors and piezoactuators at one or more places of the helicopter H. Thus, at least one additional sensor can be arranged, for example, in the passenger cabin 20 of the helicopter H. Furthermore, the introduction of the out-of-phase elongations and/or contractions by means of the actuators 12 can take place in the immediate vicinity of such places of the tail boom 2, 22 where a bending line of the tail boom 2, 22 exhibits a discontinuity site. As already mentioned above, with the helicopter H shown in FIG. 5, this is the case, for example, with the separation plane T formed by the folding mechanism.

Although the method according to the invention was described above only in conjunction with the tail shake effect, the invention is, of course, not limited to this vibration form. The detection and damping of the vertical eigenform (vertical bouncing) of the tail boom vibrations can fundamentally be carried out by providing appropriately arranged actuators (for instance, on the top and bottom of the tail boom) analogously to the detection and damping of the lateral eigenform (tail shake). The same applies to combined vibration forms or vibrations that have a direction that is neither lateral nor vertical. In this context, vibration sensors are to be provided that can detect vibrations in the vibration direction that occurs for the vibration form in question or in several directions.

The effectiveness and capability of the solution according to the invention was substantiated within the scope of practical experiments involving active as well as passive damping using an actual tail boom of a helicopter suspended in a test field.

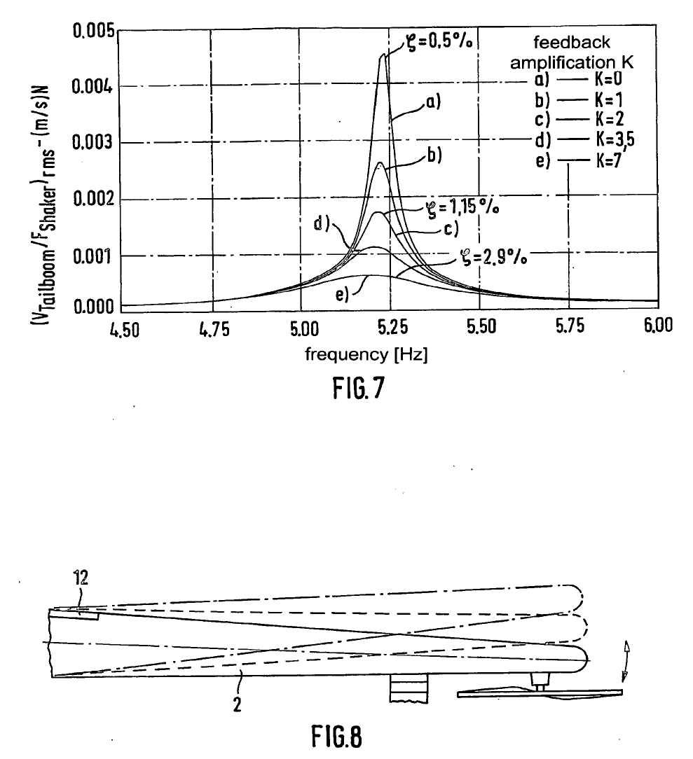

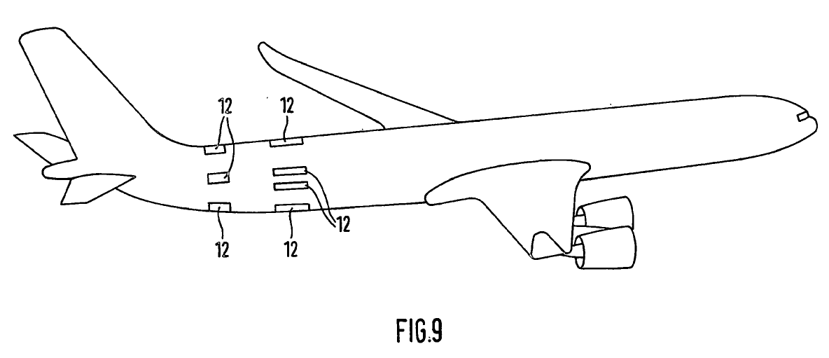

FIG. 7 shows a schematic diagram to illustrate by way of an example the tail boom damping behavior that can be achieved with the method according to the invention in terms of the tail shake effect in a helicopter according to the invention. The test series upon which this diagram is based used an active tail boom vibration-damping device with piezoceramic actuators made by the ACX company, which are each made up of two consecutively arranged piezoceramic wafers per plane with two planes located above each other. A vibration velocity pick-up was used as the vibration sensor.

The damping ζ of the first lateral eigenform (tail shake) of the tail boom structure achieved with this active vibration-damping system under constant external excitation as a function of different feedback amplifications is shown in curves a) to e) as a force-normalized vibration velocity V_{tailboom}/Fₛₕₐₖₑᵣ (in [m/s]/N) over the frequency f (in Hz). As can be seen in FIG. 7, in the frequency range shown, an increase in the tail boom structure damping from 0.5% to 2.9% could be achieved. Comparable results can also be achieved with a damping of the first vertical eigenform (vertical bouncing).

FIG. 8 shows a schematic top view of a tail boom area of a rotary-wing aircraft according to the invention (here a helicopter) according to a third embodiment. In this example, the tail boom 2 is pre-bent on one side essentially in the direction of the vibration that is to be damped (here: lateral eigenform, that is to say, tail shake; indicated by a double-headed arrow in FIG. 8). For purposes of illustration, the pre-bending is shown in a greatly exaggerated form with a continuous contour line. At least one actuator 12 is arranged on a side area of the tail boom 2 in an asymmetrical arrangement relative to the middle longitudinal axis L. In this case, the actuator 12 is configured in such a way that it can only generate tensile forces and transfer them to or introduce them into the tail boom structure. In a neutral operating state, the actuator 12 is actuated in such a way that it first pulls the tail boom 2 straight or bends it (dotted contour line), as a result of which the tail boom 2 is elastically pre-tensioned against the effect of the actuator 12. If tail boom vibrations occur (here: tail shake), the actuator 12 is activated out-of-phase with respect to tail boom vibrations or it is switched into a deactivated state. In the activated state of the actuator 12, the out-of-phase strain is introduced into the tail boom 2 by an active actuation movement of the actuator 12. In this process, the tail boom 2 is bent opposite to the direction of the pre-bending (dot-dashed contour line). In contrast, in the deactivated state of the actuator 12, the pre-tensioned tail boom 2 assumes this task itself. In other words, the elastic recovery effect of the tail boom 2, which was previously pre-tensioned by the actuator 12 or deflected in the opposite direction, now results in an out-of-phase strain or bending of the tail boom 2. Thus, once again, the desired damping of the tail boom vibration can be achieved.

The damping method described in conjunction with FIG. 8 functions in an analogous manner when the tail boom 2 is not pre-bent but rather is pre-tensioned, for instance, by means of a separate pre-tensioning element such as, for example, a spring. If the actuator(s) used can be actuated in at least two actuation directions, then the asymmetrical actuator arrangement can, of course, also be achieved without a pre-tensioning or pre-bending of the tail boom. Depending on the vibration form to be damped, the at least one actuator—in the case of an asymmetrical actuator arrangement—is arranged either on the top, the bottom, the left-hand side or the right-hand side of the tail boom (including its transition area to the fuselage or any other add-on components) or at corresponding intermediate positions.

The invention is not limited to the embodiments described above, which serve merely to generally explain the core idea of the invention. On the contrary, within the protective scope, the rotary-wing aircraft according to the invention and the method according to the invention can also assume embodiments and refinements that differ from those described in concrete terms above. Thus, for example, in certain application cases, the vibration sensors can also be arranged on add-on components that are attached to the tail boom, e.g. on a horizontal tail unit or rudder unit, tail rotor cladding or the like. Moreover, the actuators of the tail boom vibration-damping device can also be used at other vibration-relevant areas of the tail boom such as, for example, the front and back end areas of the tail boom, at transition areas leading to horizontal tail units or rudder units as well as to tail rotor components or directly on said components.

Furthermore, the actuators can be arranged such that their effective direction runs at a slanted angle (e.g. of 45°) with respect to the longitudinal axis of the tail boom. In this context, the effective directions of several actuators can intersect each other. Such an arrangement can be used in combination with a suitable sensor, for example, for damping torsional vibrations. However, with a suitable, for example, electronic or mechanical combination, several actuators with such a slanted arrangement can also be used to damp the tail shake or the vertical bouncing. This can be achieved, for example, in that at least two such actuators are actuated at the same time and the direction of the force vector resulting from the actuation effect of both actuators runs essentially parallel to the middle longitudinal axis of the tail boom and at a distance from it.

In addition to the described piezoactuators, other types of actuators are also conceivable, e.g. electric, electromechanical, electromagnetic, hydraulic, mechanical actuators or the like as well as combined forms of these. In order to achieve an actuation effect, the actuators can also be combined with pre-tensioning means such as, for example, springs or the like.

Although the solution according to the invention was previously described in conjunction with the damping of tail boom vibrations of rotary-wing aircraft, it has been found that this solution is also fundamentally suited for the damping of vibrations that occur, for example, in the lateral and/or vertical direction (or in intermediate directions) on a fuselage, especially on a tail area of a fixed-wing airplane (see FIG. 9). Particularly in the case of airplanes with a very long fuselage, vibration phenomena can be observed that are similar to those found in the tail boom of a rotary-wing aircraft. The fuselage or fuselage tail vibrates to an extent that is unpleasant for passengers who are seated in these areas of the fuselage. It has been found that the solution according to the invention previously described for a tail boom of a rotary-wing aircraft can largely be transferred to the damping of fuselage or fuselage tail vibrations of large fixed-wing airplanes and can contribute to the comfort of passengers. Torsional vibrations of the fuselage can also be damped. Consequently, the explanations and examples given above also apply analogously to fixed-wing airplane applications.

In this case, analogous to the rotary-wing aircraft, the installation site for the actuators is either on the skin of the airplane fuselage (inside or outside) or on those fuselage reinforcement elements, especially stringers, on or to which the skin of the airplane is attached (e.g. by bonding or riveting). However, it is also possible to provide separate pulling and/or pushing elements that engage with the actuators and with the appertaining fuselage structure. The actuators are once again preferably arranged on the right and left in the direction of flight (shake) or on the top and bottom (vertical bouncing) on the airplane fuselage or behind the wing. Combinations of these installation sites are possible. Preferably, the actuators are once again placed at the places with the highest strain energy. When the actuators are installed on the inside of the airplane skin or inside the fuselage, this has no (negative) aerodynamic effect. Due to the interior insulation or paneling normally present in the an airplane cabin, the actuators do not have a detrimental effect and no complicated surface protection measures are needed. However, a certain minimum covering of the actuators is necessary in any case.

The arrangement of the vibration sensors can be configured analogously to the examples above. Moreover, due to the size of an airplane fuselage, however, it is also conceivable to arrange the sensors only in the fuselage tail area. Regarding the variant shown in FIG. 5, it is possible, for example, to arrange the vibration sensor 10b in a front tail area and the vibration sensor 10a in a rear tail area. Other sensor positions on other fuselage areas are likewise feasible. For other possible embodiments, once again, reference is made to the preceding examples.

Reference numerals in the claims, in the description and in the drawings serve merely for better comprehension of the invention and are not to be construed as a limitation of the protective scope.

What is claimed is:

1. A method for damping vibrations in a tail boom of a rotary-wing aircraft, the method comprising:
detecting tail boom vibrations induced by external vibration excitation; and
generating and introducing strains into the tail boom based on the detected tail boom vibrations, the strains being applied over a surface area and being out-of-phase with respect to the detected tail boom vibrations; and
damping the externally excited induced tail boom vibrations.

2. The method as recited in claim 1, wherein the rotary-wing aircraft is a helicopter.

3. The method as recited in claim 1, wherein the introducing of the strains is performed at locations of the tail boom having a highest structural strain energy.

4. The method as recited in claim 1, wherein the introducing of the strains is performed in a vicinity of locations of the tail boom wherein a bending line of the tail boom exhibits a discontinuity site.

5. The method as recited in claim 1, wherein the detecting of the tail boom vibrations is performed by measuring induced structural strains of the tail boom.

6. The method as recited in claim 1, wherein the detecting of the tail boom vibrations is performed by measuring vibration velocities of the tail boom.

7. The method as recited in claim 1, wherein the tail boom vibrations are detected at the tail boom.

8. The method as recited in claim 1, wherein the tail boom vibrations are detected in at least one of a cockpit area and a passenger cabin area of the rotary-wing aircraft.

9. The method as recited in claim 1, wherein the introducing of the strains includes introducing the strains into the tail boom with an out-of-phase strain velocity.

10. The method as recited in claim 1, wherein the detecting includes detecting a lateral eigenform of the tail boom vibrations.

11. The method as recited in claim 1, wherein the detecting includes detecting a vertical eigenform of the tail boom vibrations.

12. A rotary-wing aircraft, comprising:
a fuselage;
a cockpit area integrated into the fuselage;
a tail boom arranged on the fuselage; and
a tail boom vibration-damping device having at least one sensor element configured to detect tail boom vibrations induced by external vibration excitation and at least one actuator configured to generate and introduce strains into the tail boom that are out-of-phase with respect to the induced tail boom vibrations, the actuator being functionally coupled to the sensor element, engaging with a tail boom structure at one side of the tail boom, and forming a flat-surfaced bond with the tail boom.

13. The rotary-wing aircraft as recited in claim 12, wherein the rotary-wing aircraft is a helicopter.

14. The rotary-wing aircraft as recited in claim 12, wherein the tail boom vibration-damping device includes at least two actuators that engage with the tail boom structure on opposite sides of the tail boom relative to a cross section of the tail boom and form a flat-surfaced bond with the tail boom, the actuators being functionally coupled to the sensor element, for generating and introducing the strains into the tail boom.

15. The rotary-wing aircraft as recited in claim 12, wherein the at least one actuator is arranged on only one side of the tail boom or on only one side of a transition area between the tail boom and an add-on component, said side being selected from a group of sides consisting of a top side, a bottom side, a left-hand side and a right-hand side of the tail boom.

16. The rotary-wing aircraft as recited in claim 12, wherein the at least one actuator includes at least two actuators, one of the at least two actuators being disposed on a left-hand side and another of the at least two actuators being disposed on a right-hand side of one of the tail boom and a transition area between the tail boom and an add-on component.

17. The rotary-wing aircraft as recited in claim 12, wherein the at least one actuator includes at least two actuators, one of the at least two actuators being disposed on a top side and another of the at least two actuators being disposed on a bottom side of one of the tail boom and a transition area between the tail boom and an add-on component.

18. The rotary-wing aircraft as recited in claim 12, wherein the at least one actuator is applied onto the tail boom structure.

19. The rotary-wing aircraft as recited in claim 12, wherein the at least one actuator is integrated into the tail boom structure.

20. The rotary-wing aircraft as recited in claim 12, wherein the tail boom is one of pre-tensioned and pre-bent essentially in a first direction of the vibration to be damped and is connected to the at least one actuator, the at least one actuator being actuatable in a second direction opposite to the first direction.
